(19) United States
(12) Patent Application Publication
(10) Pub. No.: US 2020/0028167 A1
(43) Pub. Date: Jan. 23, 2020

(54) SECONDARY BATTERY

(71) Applicant: NGK INSULATORS, LTD., Nagoya-Shi (JP)

(72) Inventor: Naohito YAMADA, Nagoya-Shi (JP)

(73) Assignee: NGK INSULATORS, LTD., Nagoya-Shi (JP)

(21) Appl. No.: 16/585,551

(22) Filed: Sep. 27, 2019

Related U.S. Application Data
(63) Continuation of application No. PCT/JP2018/011199, filed on Mar. 20, 2018.

(30) Foreign Application Priority Data
Apr. 26, 2017 (JP) 2017-086971

(51) Int. Cl. H01M 4/50; H01M 4/38; H01M 4/48; H01M 10/0562; H01M 4/62

(52) U.S. Cl. CPC H01M 4/502; H01M 4/38; H01M 2300/0068; H01M 10/0562; H01M 4/625; H01M 4/483

(57) ABSTRACT

There is provided a secondary battery including: a positive electrode containing manganese dioxide and/or manganese hydroxide, a conductive aid, and a hydroxide-ion-conductive inorganic solid electrolyte; a negative electrode containing zinc and/or zinc hydroxide, a conductive aid, and a hydroxide-ion-conductive inorganic solid electrolyte; and a separator containing a hydroxide-ion-conductive inorganic solid electrolyte, the separator separating the positive electrode from the negative electrode.

### CROSS-REFERENCE TO RELATED APPLICATIONS

This application is a continuation application of PCT/JP2018/011199 filed Mar. 20, 2018, which claims priority to Japanese Patent Application No. 2017-086971 filed Apr. 26, 2017, the entire contents all of which are incorporated herein by reference.

### BACKGROUND OF THE INVENTION

### 1. Field of the Invention

The present invention relates to a secondary battery, in particular to a manganese-zinc secondary battery.

### 2. Description of the Related Art

Alkaline manganese dry cells (also referred to as alkaline dry cells) have been widely prevailed as primary batteries. In particular, alkaline manganese dry cells with a zinc negative electrode and an aqueous alkaline electrolytic solution are broadly used because of high versatility and inexpensiveness of the cells. For example, PTL 1 (JP2012-28240A) discloses an alkaline manganese dry cell provided with a negative electrode containing zinc powder and an alkaline electrolytic solution.

In general, zinc used in a negative electrode active material has some advantages, such as a large theoretical discharge capacity per unit mass of 820 mAh/g, low toxicity, low environmental load, and inexpensiveness. In particular, irregular-shaped zinc powder produced by, for example, a gas atomization process is used in the negative electrode active material of the alkaline manganese dry cell. The discharge reaction in the cell is generally represented by the following formulae.

Negative electrode: Zn(s)+2OH⁻(aq)→ZnO(s)+H₂O(l)+2e⁻

Positive electrode: 2MnO₂(s)+H₂O(l)+2e⁻→Mn₂O₃(s)+2OH⁻(aq)

The alkaline manganese dry cell is a primary cell, which cannot be charged for the following reason: In the discharge reaction, K ions in a KOH electrolytic solution penetrate into MnO₂ particles even in a low discharge state of MnO₂, and Zn ions also penetrate into the MnO₂ particles as the discharge reaction proceeds. K and Zn that have penetrated in the particles stay in the particles without being released from the particles even in the charge reaction. In other words, a final product in the discharge reaction is hydrohetaerolite (ZnMn₂O₄.H₂O), and intermediate products up to the final product are Mn₃O₄ and KMnO₄. The latter intermediate product is partially produced mainly in an intermittent charge-discharge reaction. Mn₃O₄ transforms to KMnO₄ in the charge reaction, but does not return to the original state of MnO₂. KMnO₄ immediately transforms into hydrohetaerolite upon discharging. Accordingly, regardless of the discharged rate, K and Zn once having penetrated into the MnO₂ particles are barely released from the particles during the charge cycle, resulting in irreversible transformation that precludes charging.

In the fields of nickel-zinc secondary batteries and air-zinc secondary batteries, use of a hydroxide-ion-conductive inorganic solid electrolyte separator, in particular a layered double hydroxide (LDH) separator, has been recently proposed. Hydroxide-ion-conductive inorganic solid electrolyte separators, such as an LDH separator, can selectively permeate hydroxide ions and prevent penetration of dendritic zinc growing from the negative electrode in the alkaline electrolytic solution, resulting in preventing the short circuit between positive and negative electrodes due to the dendritic zinc. For example, PTL 2 (WO2016/076047A) discloses a separator structure containing an LDH separator fitted or jointed to a resin outer frame. The LDH separator is provided in the form of a composite material with a porous substrate. Furthermore, PTL 3 (WO2016/067884A) discloses several processes for providing an LDH dense film on the surface of a porous substrate to form a composite material. In these processes, a starting material capable of giving an origin of crystal growth of LDH is uniformly dispersed onto the porous substrate, and the porous substrate is subjected to hydrothermal treatment in an aqueous raw material solution to form the LDH dense film on the porous substrate.

### CITATION LIST

### Patent Literature

PTL 1: JP2012-28240A

PTL 2: WO2016/076047A

PTL 3: WO2016/067884A

### SUMMARY OF THE INVENTION

As described above, in the alkaline manganese dry cell, Zn ions dissolved in the electrolytic solution and K ions of KOH, which is the main component of the electrolytic solution, inhibit a reversible charge reaction. In other words, the alkaline manganese dry cell generally contains a KOH electrolytic solution; hence, Zn ions are also dissolved due to strong alkaline of KOH, K ions and Zn ions are present in the electrolytic solution and interact with MnO₂, which is a positive electrode active material. In this mechanism, the interaction of K ions and Zn ions at least with MnO₂ needs to be avoided to maintain rechargeability to the cell.

The present inventors have discovered that by allowing a positive electrode and a negative electrode to contain a conductive aid and a hydroxide-ion-conductive inorganic solid electrolyte and separating the positive electrode from the negative electrode with a separator containing a hydroxide-ion-conductive inorganic solid electrolyte, such as an LDH separator, it is possible to provide a manganese-zinc secondary battery that can be reversibly charged and discharged without a KOH electrolytic solution.

Accordingly, an object of the present invention is to provide a manganese-zinc secondary battery that can be reversibly charged and discharged without a KOH electrolytic solution.

According to one embodiment in the present invention, a secondary battery is provided. The secondary battery comprises:
a positive electrode containing manganese dioxide and/or manganese hydroxide, a conductive aid, and a hydroxide-ion-conductive inorganic solid electrolyte;
a negative electrode containing zinc and/or zinc hydroxide, a conductive aid, and a hydroxide-ion-conductive inorganic solid electrolyte; and
a separator containing a hydroxide-ion-conductive inorganic solid electrolyte, the separator separating the positive electrode from the negative electrode.

### BRIEF DESCRIPTION OF THE DRAWINGS

FIG. 1 is a conceptual view of a secondary battery according to the present invention.

### DETAILED DESCRIPTION OF THE INVENTION

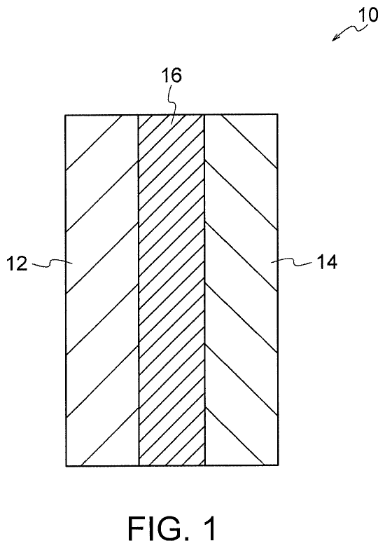

FIG. 1 conceptually illustrates a secondary battery 10 according to the present invention. As shown in FIG. 1, the secondary battery 10 comprises a positive electrode 12, a negative electrode 14, and a separator 16. The positive electrode 12 contains manganese dioxide and/or manganese hydroxide, a conductive aid, and a hydroxide-ion-conductive inorganic solid electrolyte. The negative electrode 14 contains zinc and/or zinc hydroxide, a conductive aid, and a hydroxide-ion-conductive inorganic solid electrolyte. The separator 16 contains a hydroxide-ion-conductive inorganic solid electrolyte and separates the positive electrode 12 from the negative electrode 14. As described above, the positive electrode 12 and the negative electrode 14 contain the conductive aid and the hydroxide-ion-conductive inorganic solid electrolyte, and are separated from each other by the separator 16 containing the hydroxide-ion-conductive inorganic solid electrolyte, such as the LDH separator. In this configuration, the manganese-zinc secondary battery 10 can be reversibly charged and discharged without a KOH electrolytic solution.

As described above, in the alkaline manganese dry cell, Zn ions dissolved in the electrolytic solution and K ions of KOH, which is a main component of the electrolytic solution, inhibit a reversible charge reaction. In other words, the alkaline manganese dry cell generally contains a KOH electrolytic solution; hence, Zn ions are also dissolved due to strong alkaline of KOH. K ions and Zn ions present in the electrolytic solution interact with MnO₂, which is a positive electrode active material, and inhibit the reversible charge reaction in the cell. In contrast, the secondary battery of the present invention employs a hydroxide ion (OH⁻) similar to the alkaline cell as an ion conductive species, specifically contains a hydroxide-ion-conductive inorganic solid electrolyte in place of an aqueous KOH solution as the electrolytic solution, and does not have such a disadvantage. In this manner, the K ions and the Zn ions do not react with MnO₂, which is the positive electrode active material, and the discharged product of MnO₂ is reversibly charged to return to MnO₂. The manganese-zinc secondary battery 10 can thereby be reversibly charged and discharged. Since the secondary battery 10 is typically free from an alkaline electrolytic solution (e.g., the aqueous KOH solution), it is basically categorized into an all-solid-state secondary battery.

The charge reaction in the secondary battery 10 of the present invention is represented by the following formulae, and the discharge reaction is represented as the reverse of the following formulae.

Positive electrode: Mn(OH)₂+2OH⁻→MnO₂+2H₂O+2e⁻

Negative electrode: Zn(OH)₂+2e⁻→Zn+2OH⁻, or ZnO+H₂O+2e⁻→Zn+2OH⁻

The positive electrode 12 contains manganese dioxide and/or manganese hydroxide, and the negative electrode 14 contains zinc and/or zinc hydroxide. Manganese dioxide and/or manganese hydroxide is a positive electrode active material, and zinc and/or zinc hydroxide is a negative electrode active material. As described above, the secondary battery 10 of the present invention can contain the positive electrode active material and the negative electrode active material composed of manganese dioxide and zinc, respectively, which are used in conventional alkaline manganese dry cells. In particular, the secondary battery 10 of the present invention can be manufactured either in a fully charged or discharged state of the active materials.

The secondary battery 10 in the fully charged state may be manufactured with electrolytic manganese dioxide and metallic zinc used in general alkaline manganese dry cells. Since general metallic zinc has a large particle diameter of several tens of micrometers in this case, formation of insulative Zn(OH)₂ or ZnO, which is a discharged product, on the particle surface and passivation due to covering of the surface may result in insufficient discharge. In this mechanism, it is preferred to use metallic zinc having a smaller particle diameter as much as possible. However, fine metal powder should be treated with great attention to avoid a risk of dust explosion. Accordingly, the manganese dioxide has a mean particle diameter of preferably 15 to 50 μm, more preferably 15 to 25 μm. The metallic zinc has a mean particle diameter of preferably 70 to 400 μm, more preferably 70 to 100 μm.

Alternatively, the secondary battery 10 in the fully discharged state may be advantageously manufactured with manganese hydroxide and zinc hydroxide (or zinc oxide). Since these materials have no risk of dust explosion, fine powder having a size of several micron to sub-micron order can be used. Specifically, the manganese hydroxide has a mean particle diameter of preferably 0.1 to 10 μm, more preferably 1 to 5 μm. The zinc hydroxide (or zinc oxide) has a mean particle diameter of preferably 0.1 to 10 μm, more preferably 0.5 to 5 μm. Since manganese hydroxide is readily oxidized in the atmosphere, specific measures should desirably be taken to avoid oxidation in the use of such manganese hydroxide as a raw material. It is thus more preferred that the secondary battery 10 be manufactured in the fully charged state because battery grade powders of manganese dioxide and metallic zinc can be produced at low costs on an industrial scale without any specific measure.

Both the positive electrode 12 and the negative electrode 14 contain a conductive aid, which facilitates the transfer of electrons in the positive electrode 12 and the negative electrode 14. In a typical alkaline manganese dry cell, the zinc in the negative electrode has electrical conductivity and thereby requires no conductive aid. In contrast, in the negative electrode 14 of the rechargeable secondary battery 10 in the present invention, Zn(OH)₂ or ZnO, which is the discharged product, has no electrical conductivity and thus requires the addition of a conductive aid to have electrical conductivity. The conductive aid to be contained in the positive electrode 12 and the negative electrode 14 is preferably a carbon material. Examples of the carbon material include a variety of conductive carbons, such as graphite, carbon black, carbon nanotubes, and graphene. The conductive aid or carbon material is preferably in a particulate form. For example, the positive electrode 12 is preferably a mixture of manganese dioxide particles and conductive carbon particles. The conductive aid or carbon material has a mean particle diameter of preferably 0.005 to 1 μm, more preferably 0.005 to 0.5 μm.

The conductive aid contained in the positive electrode 12 preferably forms a network in the positive electrode 12. The conductive aid contained in the negative electrode 14 also preferably forms a network in the negative electrode 14. Such networking of the conductive aid can improve the electrical conductivity in the positive electrode 12 and/or the negative electrode 14. Such networks are typically constructed by connection of conductive carbon particles to one another.

Both the positive electrode 12 and the negative electrode 14 contain a hydroxide-ion-conductive inorganic solid electrolyte. As described above, in the secondary battery 10 of the present invention, the hydroxide-ion-conductive inorganic solid electrolyte is used as an electrolyte in place of a KOH electrolytic solution. The solid electrolyte may be any inorganic solid electrolyte that has hydroxide ion conductivity. Examples of the hydroxide-ion-conductive inorganic solid electrolyte include layered double hydroxides (LDHs) and layered perovskite oxides, most preferably LDHs, which are inexpensive and have high hydroxide ion conductivity. In contrast, anion-conductive polymers, which are organic solid electrolytes, may be degraded by hydroxide ions. The hydroxide-ion-conductive inorganic solid electrolyte, such as the LDH, has an advantage in that no degradation occurs. The hydroxide-ion-conductive inorganic solid electrolyte or the LDH is preferably in the particulate form. The hydroxide-ion-conductive inorganic solid electrolyte or the LDH has a mean particle diameter of preferably 0.1 to 5 μm, more preferably 0.1 to 2 μm.

The hydroxide-ion-conductive inorganic solid electrolyte contained in the positive electrode 12 preferably forms a network in the positive electrode 12. The hydroxide-ion-conductive inorganic solid electrolyte contained in the negative electrode 14 also preferably forms a network in the negative electrode 14. Such networking of the hydroxide-ion-conductive inorganic solid electrolyte can improve the hydroxide ion conductivity in the positive electrode 12 and/or the negative electrode 14. Such networks are typically constructed by connection of the particles of the hydroxide-ion-conductive inorganic solid electrolyte to one another.

The separator 16 contains a hydroxide-ion-conductive inorganic solid electrolyte, and separates the positive electrode 12 from the negative electrode 14. In other words, the separator 16 is a member in the form of film, layer, or plate, and permits hydroxide ion conductivity but does not permit electron conductivity between the positive electrode 12 and the negative electrode. The separator 16 may be a compacted layer of particles produced by compaction of particles of the hydroxide-ion-conductive inorganic solid electrolyte, or may be a consolidated layer produced by a process, such as heating or hydrothermal treatment. In particular, the secondary battery 10 of the present invention, which does not require any electrolytic solution, can use the compacted layer of particles without significant disadvantages (e.g., deterioration or disintegration due to penetration of the electrolytic solution). Alternatively, the separator 16 may be a film of a hydroxide-ion-conductive inorganic solid electrolyte. The hydroxide-ion-conductive solid electrolyte may be any inorganic solid electrolyte that has hydroxide ion conductivity. Examples of the hydroxide-ion-conductive inorganic solid electrolyte include layered double hydroxides (LDHs) and layered perovskite oxides, most preferably LDHs, which are inexpensive and have high hydroxide ion conductivity. In particular, LDH separators are known (see PTLs 2 and 3) in the fields of nickel-zinc secondary batteries and air-zinc secondary batteries, as described above. Such LDH separators are preferably used also in the secondary battery 10 of the present invention. The LDH separator may be provided in the form of composite with a porous substrate as disclosed in PTLs 2 and 3. In the LDH separator, pores in the porous substrate are desirably filled with the LDH over the entire thickness. In this manner, smooth transfer of hydroxide ions can be achieved between the positive electrode 12 and the negative electrode 14 in contact with the separator 16. Accordingly, if a portion in which the pores are not filled with the LDH remains in the porous substrate, such a portion is desirably removed by, for example, trimming or polishing, to yield a separator 16.

The hydroxide-ion-conductive inorganic solid electrolyte in the positive electrode 12, the negative electrode 14 and the separator 16 is preferably LDH, as described above. In this case, particles of the LDH in the hydroxide-ion-conductive inorganic solid electrolyte in the positive electrode 12, the negative electrode 14, and the separator 16 are preferably bonded to each other to improve the hydroxide ion conductivity and thus the battery characteristics.

The LDH typically has the following general formula:
M²⁺₁₋ₓM³⁺ₓ(OH)₂Aⁿ⁻_{x/n}.mH₂O (wherein, M²⁺ is a divalent cation, M³⁺ is a trivalent cation, Aⁿ⁻ is an n-valent anion, x is 0.1 to 0.4, n is an integer of 1 or more, and m is 0 or more), and may be any hydroxide that comprises different cation components having at least two valences. The LDH may have a composition that comprises three or more cation components. For example, the LDH may have a composition, generally referred to as hydrotalcite, that consists of a divalent Mg (i.e., Mg²⁺) cation component, a trivalent Al (i.e., Al³⁺) cation component, and a CO₃²⁻ anion component. Alternatively, the LDH may have a composition that consists of a divalent Ni (i.e., Ni²⁺) cation component, a tetravalent or trivalent Ti (i.e., Ti⁴⁺ or Ti³⁺) cation component, and a trivalent Al (i.e., Al³⁺) cation component. The LDH may have any composition that exhibits an acceptable level of high hydroxide ion conductivity.

The hydroxide-ion-conductive inorganic solid electrolyte contained in the positive electrode 12, the hydroxide-ion-conductive inorganic solid electrolyte contained in the negative electrode 14, and the hydroxide-ion-conductive inorganic solid electrolyte contained in the separator 16 may be composed of an identical material or different material. The hydroxide-ion-conductive inorganic solid electrolyte contained in the positive electrode 12 and the negative electrode 14 preferably has higher electron conductivity than that contained in the separator 16 to enhance electron conductivity of the positive electrode 12 and the negative electrode 14 and insulation properties of the separator 16. It is particularly preferred that the hydroxide-ion-conductive inorganic solid electrolyte contained in the positive electrode 12 and the negative electrode 14 have higher electron conductivity and the hydroxide-ion-conductive inorganic solid electrolyte contained in the separator 16 have significantly lower electron conductivity.

The positive electrode 12, the negative electrode 14 and the separator 16 preferably contain moisture. Since the charge-discharge reaction is accompanied by generation and involvement of H₂O, the reaction can proceed more smoothly by moisture preliminarily contained in components of battery. Since the LDH exhibits higher hydroxide ion conductivity in the wet state than in the dry state, the addition of moisture is particularly effective. The moisture indicates simply H₂O and does not indicate a so-called alkaline electrolytic solution, such as an aqueous KOH solution. However, H₂O may have alkalinity after the contact with the LDH.

In the case that the positive electrode 12, the negative electrode 14 and/or the separator 16 contain LDH particles as the hydroxide-ion-conductive inorganic solid electrolyte, the components of battery may be subjected to steam treatment. Since the LDH particles are mutually connected by the steam treatment in a compressed state, the steam treatment can enhance hydroxide ion conductivity. The steam treatment includes any process that involves putting untreated substances into contact with steam at high temperature. For example, water may be added on the bottom of an autoclave, and the untreated substances may be placed above the water level, sealed and heated to 100° C. or higher to complete steam treatment.

The secondary battery 10 of the present invention, as described above, has highly practical commercial value as roughly estimated below. In the case that a size-AA conventional alkaline manganese dry cell (positive electrode/negative electrode: MnO₂/Zn, and electrolyte: KOH) has a capacity of 2000 to 2700 mAh, a volume of 7.7 cm³ (calculated from 14 mm in diameter and 50 mm in height) and a nominal voltage of 1.5 V, the cell has an electric energy of 3 to 4 Wh and a volume capacity density of 390 to 520 Wh/L. In contrast, even if the volume of the cell is two times by replacing the electrolytic solution with the LDH particles and adding the conductive aid, the secondary battery can have a volume capacity density of 190 to 260 Wh/L, which is equal to that of stationary secondary batteries other than, for example, mobile batteries. In the case that hydrotalcite is used as the LDH, a low-cost secondary battery comparable to the dry cell can be provided because expensive materials are not necessary.

What is claimed is:

1. A secondary battery comprising:
a positive electrode containing manganese dioxide and/or manganese hydroxide, a conductive aid, and a hydroxide-ion-conductive inorganic solid electrolyte;
a negative electrode containing zinc and/or zinc hydroxide, a conductive aid, and a hydroxide-ion-conductive inorganic solid electrolyte; and
a separator containing a hydroxide-ion-conductive inorganic solid electrolyte, the separator separating the positive electrode from the negative electrode,
wherein the secondary battery does not contain an alkaline electrolytic solution.

2. The secondary battery according to claim 1, wherein the hydroxide-ion-conductive inorganic solid electrolyte contained in the positive electrode, the negative electrode, and the separator comprise layered double hydroxide (LDH).

3. The secondary battery according to claim 1, wherein the conductive aid contained in the positive electrode and the negative electrode comprises a carbon material.

4. The secondary battery according to claim 1, wherein the positive electrode, the negative electrode, and the separator contain moisture.

5. The secondary battery according to claim 1, wherein the hydroxide-ion-conductive inorganic solid electrolyte contained in the positive electrode forms a network in the positive electrode, and the hydroxide-ion-conductive inorganic solid electrolyte contained in the negative electrode forms a network in the negative electrode.

6. The secondary battery according to claim 1, wherein the conductive aid contained in the positive electrode forms a network in the positive electrode, and the conductive aid contained in the negative electrode forms a network in the negative electrode.

7. The secondary battery according to claim 2, wherein the hydroxide-ion-conductive inorganic solid electrolyte contained in the positive electrode, the negative electrode, and the separator has a structure in which particles of the LDH are bonded to each other.

8. The secondary battery according to claim 1, wherein the hydroxide-ion-conductive inorganic solid electrolyte contained in the positive electrode and the negative electrode has higher electron conductivity than that of the hydroxide-ion-conductive inorganic solid electrolyte contained in the separator.
